(19) United States
(12) Patent Application Publication
(10) Pub. No.: US 2014/0371359 A1
(43) Pub. Date: Dec. 18, 2014

(54) RECYCLED RESIN COMPOSITION

(71) Applicants: Yasushi Akiba, Kanagawa (JP); Tadakatsu Harada, Kanagawa (JP)

(72) Inventors: Yasushi Akiba, Kanagawa (JP); Tadakatsu Harada, Kanagawa (JP)

(73) Assignee: RICOH COMPANY, LTD., Tokyo (JP)

(21) Appl. No.: 14/297,851

(22) Filed: Jun. 6, 2014

(30) Foreign Application Priority Data
Jun. 13, 2013 (JP) 2013-124958

(51) Int. Cl. C08L 25/06; C08J 3/20; C08J 3/00

(52) U.S. Cl. CPC C08L 25/06; C08J 3/005; C08J 3/203; C08L 2201/02; C08L 2203/20; C08L 2205/03; C08L 2207/20; C08J 2325/06; C08J 2425/06; C08J 2483/07
USPC 524/116; 524/125

(57) ABSTRACT

A recycled resin composition includes polystyrene collected from wasted home electric appliances in an amount of from 51 to 84% by weight, unused polystyrene in an amount of from 11 to 39% by weight, an impact modifier in an amount of from 2 to 4% by weight, and a phosphorous flame retardant in an amount of from 6 to 19% by weight.

### CROSS-REFERENCE TO RELATED APPLICATIONS

This patent application is based on and claims priority pursuant to 35 U.S.C. §119 to Japanese Patent Application No. 2013-124958, filed on Jun. 13, 2013, in the Japan Patent Office, the entire disclosure of which is hereby incorporated by reference herein.

### BACKGROUND

1. Technical Field

The present invention relates to a recycled resin composition, a component, an image forming apparatus and a method of producing the recycled resin composition.

2. Description of the Related Art

Many resin components are used for inner parts and the like of image forming apparatuses such as copiers and printers, electric and electronic equipment such as home electric appliances, and automobiles. These parts are required to have inflammability for the purpose of preventing fire spread. Particularly, the copier includes a fixing unit having high temperature and resin parts that are provided around the fixing unit.

In addition, the copier includes a unit generating a high voltage such as a charging unit, and an AC 100 V electric source unit. Their maximum electric power consumption is from 100 s (a few hundred) to 1,500 W and composed of 100 V, 15 A electric source system.

These copiers, mainly represented by multifunctional printers, are stationary electric and electronic equipment. International standard IEC 60950 requires a likely ignition source, such as resin materials in electric and electronic equipment, to be covered with 5VB grade enclosures meeting with UL94 standard (Underwriters Laboratories Inc., standard).

A test method of 5VB grade in the UL94 standard is defined as a “burning test with 500 W test flame” in international standard C60695-11-20 (ASTM D5048).

Besides the enclosure, components inside the enclosure are required to have flame resistance not less than V-2 grade in the UL94 standard.

A test method of V-2 grade in the UL94 standard is defined as a “vertical burning test” in international standard C60695-11-10 (ASTM D3801).

Conventional resin components are formed of resins made from petroleum, and used for home electric appliances and OA equipment. Recently, the home electric appliances have increased to 600,000 tons and most of them have been buried. However, landfills are limited and many useful recyclable resources are included in the wasted home electric appliances to be buried. In April, 2001, Home Appliance Recycling Law was executed to promote recycle of the useful resources and decrease wastes.

The Home Appliance Recycling Law requires that air conditioners, tube televisions, LC and plasma televisions, refrigerators, and washing machines and cloth driers should be recycled at not less than 70%, 55%, 50%, 60% and 65%, respectively (March, 2012).

Ratios of resin components of the recent home electric appliances and OA equipment have been increasing because the resins have many advantages such as free designability more than metals like iron, capability of receiving various properties with adjustment of constitutional components or additives, which is difficult for metals to achieve, light weight and high durability.

Polystyrene (PS) is mostly used in refrigerators, exterior materials of air conditioners and interior materials thereof. PS including rubber components in a higher ratio is used in an impact modifier to maintain strength even at high temperature or low temperature.

Polystyrene (PS) used in OA equipment is mostly used for exterior components and structural units. In an electrophotographic image forming apparatus using Carlson method, should a heat generated from the fixing unit catch fire, many polystyrene (PS) components of 5VB grade in the UL94 standard are used to prevent the fire from spreading out of the apparatus. Many polystyrene (PS) components of V-2 grade in the UL94 standard are used for interior components as well.

Japanese published unexamined application No. JP-2004-314445-A discloses a method of recycling a waste material of a thermoplastic resin composition, including a step of systematically and selectively separating and collecting a thermoplastic resin composition which is a main component in the waste material thereof, a step of mixing at least two of the selectively separated and collected waste material of the thermoplastic resin composition or its fused material, and/or the unused thermoplastic resin composition or its fused material to form a mixture having a specific composition, a step of fusing the waste material of the thermoplastic resin composition or the mixture, and a step of forming the mixed and fused waste material of the thermoplastic resin composition to obtain a thermoplastic resin composition compact.

However, polystyrene collected from wasted home electric appliances is unable to form a recycled resin composition having flame and impact resistance and good fluidity, and is not applicable to OA equipment.

### SUMMARY

Accordingly, a need exists for a recycled resin composition having flame and impact resistance and good fluidity.

Another object of the present invention is to provide a component formed of the recycled resin composition.

A further object of the present invention is to provide a component of an image forming apparatus, formed of the recycled resin composition.

Another object of the present invention is to provide an interior component of an image forming apparatus, formed of the recycled resin composition.

A further object of the present invention is to provide a component having an identification of material and grade information.

Another object of the present invention is to provide an image forming apparatus using the component formed of the recycled resin composition.

A further object of the present invention is to provide a method of preparing the recycled resin composition.

These objects and other objects of the present invention, either individually or collectively, have been satisfied by the discovery of a recycled resin composition, including polystyrene collected from wasted home electric appliances in an amount of from 51 to 84% by weight, unused polystyrene in an amount of from 11 to 39% by weight, an impact modifier in an amount of from 2 to 4% by weight, and a phosphorous flame retardant in an amount of from 6 to 19% by weight.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a diagram showing ratios of polystyrene used in typical home electric appliances; and

FIG. 2 is a schematic view illustrating an embodiment of the image forming apparatus of the present invention.

### DETAILED DESCRIPTION

The present invention provides a recycled resin composition having flame and impact resistance and good fluidity.

The recycled resin composition includes polystyrene collected from wasted home electric appliances, unused polystyrene, an impact modifier, and a phosphorous flame retardant. This imparts flame resistance to the polystyrene collected from wasted home electric appliances. The unused polystyrene mixed with the polystyrene collected from wasted home electric appliances increases drip effect of flames. In addition, the content of the flame retardant can be minimized and the cost can be reduced. Further, the polystyrene collected from wasted home electric appliances can efficiently be recycled. Furthermore, a recycled resin composition having a high recycle rate of recycling the polystyrene collected from wasted home electric appliances and low environmental load can be obtained. Therefore, the recycled resin composition is applicable to future circulating society and contributable to low carbon society.

The recycled resin composition includes the polystyrene collected from wasted home electric appliances in an amount of from 51 to 84% by weight, and preferably from 55 to 79% by weight. When less than 51% by weight, the recycled resin composition deteriorates in flame resistance. When greater than 84% by weight, the recycled resin composition deteriorates in fluidity.

The recycled resin composition includes the unused polystyrene in an amount of from 11 to 39% by weight, and preferably from 15 to 35% by weight. When less than 11% by weight, the recycled resin composition deteriorates in fluidity. When greater than 84% by weight, the recycled resin composition deteriorates in impact resistance.

The recycled resin composition includes the impact modifier in an amount of from 2 to 4% by weight, and preferably from 2.5 to 3.5% by weight. When less than 2% by weight, the recycled resin composition deteriorates in impact resistance. When greater than 4% by weight, the recycled resin composition deteriorates in fluidity.

The recycled resin composition includes the phosphorous flame retardant in an amount of from 6 to 19% by weight, and preferably from 10 to 15% by weight. When less than 6% by weight, the recycled resin composition deteriorates in flame resistance. When greater than 19% by weight, the recycled resin composition deteriorates in fluidity.

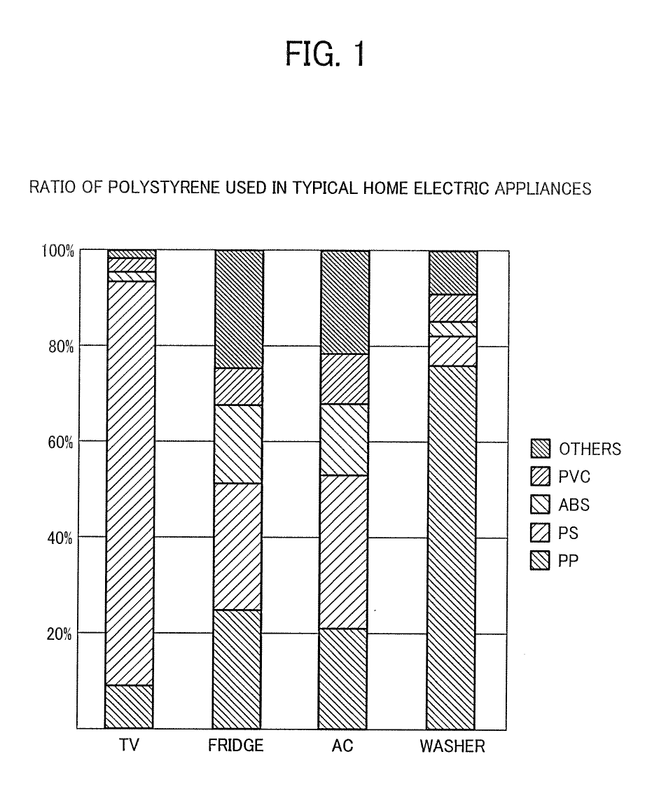

As FIG. 1 shows, the home electric appliances includes, but are not limited to, a transparent inner box, a resin door, an operation panel, a handle and a cap of a refrigerator; a front panel, a fan, an indoor/outdoor outer housing, a ventilating hole and an air direction plate of an air conditioner; an outer component, an inner component and a frame component of a television; and a washing machine.

Polystyrene used for the home electric appliances includes, but is not limited to, impact-resistant polystyrene (HIPS).

Specific examples of marketed polystyrene include, but are not limited to, Toyo Styrol HI from Toyo Styrene Co., Ltd., PSJ-polystyrene HIPS from PS Japan Corp. and Estyrene from Nippon Steel & Sumikin Chemical Co., Ltd.

Next, a method of collecting polystyrene from wasted home electric appliances is explained. First, after the wasted home electric appliances are collected according to the Home Appliance Recycling Law, plastic wastes are separated to extract polystyrene to be crushed. Next, the crushed polystyrene is washed, dehydrated and dried.

Specific examples of the unused polystyrene include, but are not limited to, general-purpose polystyrene (GPPS).

Specific examples of marketed general-purpose polystyrene include, but are not limited to, Toyo Styrol GP from Toyo Styrene Co., Ltd., GPPS from PS Japan Corp. and Estyrene from Nippon Steel & Sumikin Chemical Co., Ltd.

Specific examples of the impact modifier include, but are not limited to, polymers, e.g., composite rubbers such as acrylic rubbers, silicone rubbers, polybutadiene, styrene-butadiene-copolymers, acrylonitrile-butadiene copolymers, ethylene-α-olefin copolymers and silicone-acrylic rubbers.

Specific examples of marketed impact modifier include, but are not limited to, METABLEN S from Mitsubishi Rayon Co., Ltd.

Specific examples of the phosphorous flame retardant include, but are not limited to, triphenyl phosphate, cresyl phenyl phosphate, tricresyl phosphate, trixylenyl phosphate, tris(t-butylated phenyl)phosphate, tris(i-propylated phenyl)phosphate, 2-ethylhexyldiphenyl phosphate, 1,3-phenylenebis(diphenyl phosphate), 1,3-phenylenebis(dixylenyflphosphate, bisphenol A (diphenyl phosphate), tris(dichloropropyl)phosphate, tris(β-chloropropyflphosphate, tris(chloroethyl)phosphate, 2,2-bis(chloromethyl)trimethylenebis(bis(2-chloroethyl)phosphate), polyoxyalkylenebisdichloroalkyl phosphate, and red phosphorus.

The recycle resin composition may further include various additives such as compatibilizers, plasticizers, antioxidants, ultraviolet absorbers, processing aids, antistats, colorants, and hydrolysis suppressors.

The recycle resin composition can be prepared by melting and kneading a composition including the polystyrene collected from wasted home electric appliances, the unused polystyrene, the impact modifier and the flame retardant.

The recycle resin composition is applicable to components of OA equipment such as image forming apparatuses, and can reduce environmental load.

Methods of molding the recycled resin composition of the present embodiment include, but are not limited to, injection molding methods, extrusion molding methods, and hot-press molding methods.

The OA equipment includes, but are not limited to, image forming apparatuses.

Methods of the image forming apparatuses include, but are not limited to, electrophotographic methods, printing methods, inkjet methods.

The components of the image forming apparatuses include, but are not limited to, inner components thereof such as exterior covers, interior covers, air stream ducts, and image forming covers.

The components may identifiably have information showing materials and grades. The components are collected after used and utilized again as recycled resin compositions, which can further reduce environmental load.

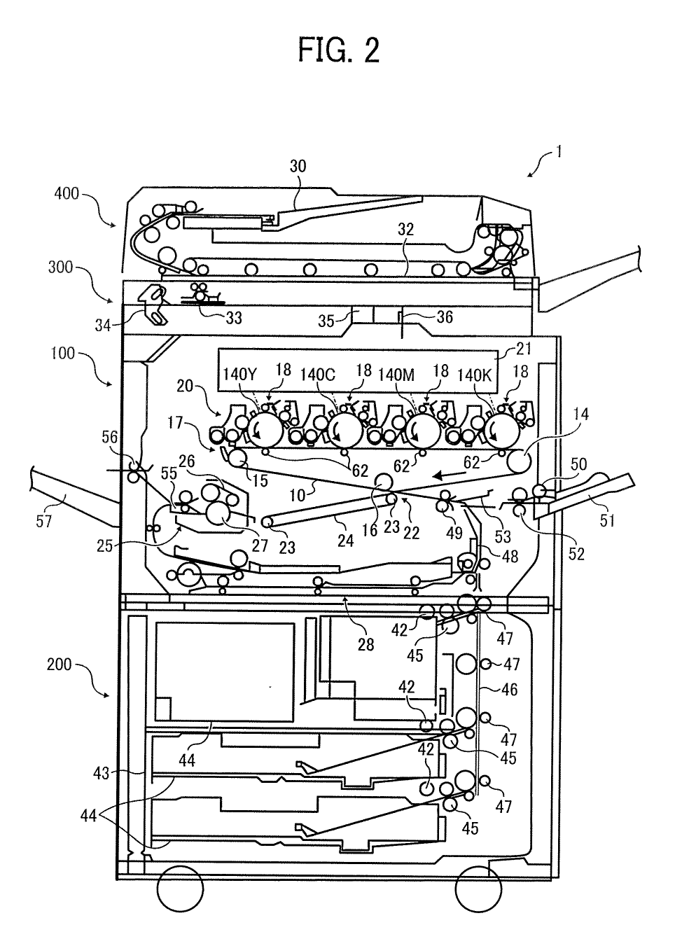

FIG. 2 is a tandem-type electrophotographic apparatus 1 using indirect transfer method as an embodiment of the image forming apparatus of the present invention.

Housing structures such as an image forming unit 18, an intermediate transferer 10, and a second transfer device 22 are required to have dimensional precision and high strength in order to for stable image forming quality to be realized, and also required to have sufficient flame retardancy because they are disposed near a fixing device 25. Therefore, polystyrene meeting with V-2 grade of UL 94 standard has conventionally been used.

The image forming apparatus 100 includes a sheet feeding table 200 on which the apparatus 100 is mounted, a scanner 300, and an automatic document feeder (ADF) 400.

An endless-belt-shaped intermediate transferer 10 is provided in approximately the center of the apparatus body 100. The intermediate transferer 10 is tensed over support rollers 14, 15, and 16, and is rotatable clockwise, for example. An intermediate transferer cleaner 17 is provided near the support roller 15, for removing residual toner on the intermediate transferer 10.

Above the intermediate transferer 10 tensed between the support rollers 14 and 15, there is provided a tandem image developer 20 including four image forming units 18 for yellow, cyan, magenta, and black that face the intermediate transferer and are arranged side by side along the conveying direction of the intermediate transferer.

An irradiator 21 is provided near the tandem image developer 20.

A second transferer 22 is provided on a side of the intermediate transferer 10 opposite to the side thereof on which the tandem image developer 20 is provided.

In the second transferer 22, a second transfer belt 24, which is an endless belt, is tensed between a pair of rollers 23. The second transferer 22 is pressed against the support roller 16 through the intermediate transferer 10 to transfer an image thereon onto a sheet.

A fixer 25 is provided near the second transferer 22.

The fixer 25 includes a fixing belt 26, which is an endless belt, and a pressurizing roller 27, which is provided pressed by the fixing belt.

Then, the second transferer 22 transfers the sheet after the image is transferred thereon to the fixer 25.

A transfer roller or a contactless charger may be provided as the second transferer 22.

A sheet overturning device 28 for overturning a transfer sheet in order for images to be formed on both sides of the transfer sheet is provided near the second transferer 22 and the fixer 25 in parallel with the tandem image developer 20.

In the electrophotographic apparatus 1, each of the image forming units 18 includes a charger, an image developer, a first transferer 62, a cleaner and a discharger around a drum-shaped photoreceptor 140 (140Y to 140K).

Next, formation of a full-color image with the electrophotographic apparatus 1 will be explained. First, a document is set on a document table 30 of the automatic document feeder (ADF) 400, or alternatively, the automatic document feeder 400 is opened, the document is set on a contact glass 32 of the scanner 300, and then the automatic document feeder 400 is closed. When a start switch not shown is depressed, the scanner 300 is started and a first traveling member 33 and a second traveling member 34 are started to run, after the document is conveyed and moved onto the contact glass 32 when the document has been set on the automatic document feeder 400, or immediately after the start switch is depressed when the document has been set on the contact glass 32. Then, the document is irradiated with light from the light source by the first traveling member 33, and light reflected from the surface of the document is reflected on a mirror of the second traveling member 34 to be received by a reading sensor 36 through an imaging lens 35.

Furthermore, when the start switch not shown is depressed, a driving motor not shown starts one of the support rollers 14, 15, and 16 to rotate and induces following rotation of the remaining two support rollers to thereby convey the intermediate transferer 10 to rotate. At the same time, each of the image forming units 18 rotates a photoreceptor 140 to form a monochrome black image, a yellow image, a magenta image, and a cyan image on the respective photoreceptor 140Y, 140C, 140M and 140K. As the intermediate transferer 10 is conveyed, the monochrome images are sequentially transferred onto the intermediate transferer 10 to from a synthesized color image thereon.

In the sheet feeding table 200, one of sheet feeding rollers 42 is selectively rotated to bring forward sheets (recording sheets) from one of sheet feeding cassettes 44 provided multi-stages in a paper bank 43. The sheets are sent forth to a sheet feeding path 146 one by one separately via a separating roller 45, conveyed by a conveying roller 47 to be guided to a sheet feeding path 48, and stopped by being struck on a registration roller 49. Alternatively, it is also possible that a sheet feeding roller 50 be rotated to bring forward recording sheets on a manual feeding tray 51, and the sheets be let into a manual sheet feeding path 53 one by one separately via a separating roller 52 and stopped at the registration roller 49.

Then, the registration roller 49 is started to rotate to send forth a recording sheet to between the intermediate transferer 10 and the second transferer 22 so as to be in time for the composite color image synthesized on the intermediate transferer 10.

The recording sheet on which the color image is formed is conveyed by the second transferer 22 to the fixer 25, and has the composite color image fixed thereon by the fixer 25 by heat, pressure, or both thereof. After this, the recording sheet is switched by a switching claw 55 to a discharging roller 56 to be discharged and stacked on a sheet discharging tray 57.

The cleaner 17 removes a residual toner on the intermediate transferer 10.

The registration roller 1049 is typically earthed, and may be applied with a bias to remove paper dusts.

### EXAMPLES

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### Example 1

The following materials were subjected to dry blending to prepare a mixture.

| | |
|---|---|
| Impact modifying polystyrene (HIPS) | 60 |
| collected from home electric appliances | |
| General-purpose polystyrene | 22 |
| Toyo styrol GP-G100C from Toyo Styrene Co., Ltd. | |
| Impact modifier | 3 |
| S-2001 from Mitsubishi Rayon Co., Ltd. | |
| Phosphorous flame retardant | 15 |
| PX-200 from Daihachi Chemical Industry Co., Ltd. | |

The mixture was placed by a hopper in a biaxial kneading extruder KZW20TW from Technovel Corp., and melted and kneaded at 210° C. thereby to prepare a pellet of 3 mm square.

### Example 2

The following materials were subjected to dry blending to prepare a mixture.

| | |
|---|---|
| Impact modifying polystyrene (HIPS) | 65 |
| collected from home electric appliances | |
| General-purpose polystyrene | 17 |
| PSJ-polystyrene GPPS679 from PS Japan Corp. | |
| Impact modifier | 3 |
| S-2001 from Mitsubishi Rayon Co., Ltd. | |
| Phosphorous flame retardant | 15 |
| PX-200 from Daihachi Chemical Industry Co., Ltd. | |

The mixture was placed by a hopper in a biaxial kneading extruder KZW20TW from Technovel Corp., and melted and kneaded at 210° C. thereby to prepare a pellet of 3 mm square.

### Example 3

The procedure for preparation of the pellet of 3 mm square In Example 1 was repeated except for replacing 15 parts of phosphorous flame retardant PX-200 from Daihachi Chemical Industry Co., Ltd, with 12 parts thereof and 3 parts of phosphorous flame retardant FP-110 from FUSHIMI Pharmaceutical Co., Ltd.

### Example 4

The procedure for preparation of the pellet of 3 mm square In Example 2 was repeated except for replacing 15 parts of phosphorous flame retardant PX-200 from Daihachi Chemical Industry Co., Ltd. with 12 parts thereof and 3 parts of phosphorous flame retardant FP-110 from FUSHIMI Pharmaceutical Co., Ltd.

### Example 5

The procedure for preparation of the pellet of 3 mm square In Example 2 was repeated except for replacing 15 parts of phosphorous flame retardant PX-200 from Daihachi Chemical Industry Co., Ltd. with 13 parts thereof and 2 parts of phosphorous flame retardant FP-110 from FUSHIMI Pharmaceutical Co., Ltd.

### Comparative Example 1

One hundred (100) parts of polystyrene collected from home electric appliances were melted and kneaded at 210° C. by a biaxial kneading extruder KZW20TW from Technovel Corp. to prepare a pellet of 3 mm square.

### Comparative Example 2

The following materials were subjected to dry blending to prepare a mixture.

| | |
|---|---|
| Impact modifying polystyrene (HIPS) | 50 |
| collected from home electric appliances | |
| General-purpose polystyrene | 40 |
| Toyo styrol GP-G100C from Toyo Styrene Co., Ltd. | |
| Phosphorous flame retardant | 10 |
| PX-200 from Daihachi Chemical Industry Co., Ltd. | |

The mixture was placed by a hopper in a biaxial kneading extruder KZW20TW from Technovel Corp., and melted and kneaded at 210° C. thereby to prepare a pellet of 3 mm square.

### Comparative Example 3

The following materials were subjected to dry blending to prepare a mixture.

| | |
|---|---|
| Impact modifying polystyrene (HIPS) | 85 |
| collected from home electric appliances | |
| Impact modifier | 10 |
| S-2001 from Mitsubishi Rayon Co., Ltd. | |
| Phosphorous flame retardant | 5 |
| PX-200 from Daihachi Chemical Industry Co., Ltd. | |

The mixture was placed by a hopper in a biaxial kneading extruder KZW20TW from Technovel Corp., and melted and kneaded at 210° C. thereby to prepare a pellet of 3 mm square.

### Comparative Example 4

The following materials were subjected to dry blending to prepare a mixture.

| | |
|---|---|
| Impact modifying polystyrene (HIPS) | 65 |
| collected from home electric appliances | |
| General-purpose polystyrene | 10 |
| Toyo styrol GP-G100C from Toyo Styrene Co., Ltd. | |
| Impact modifier | 1 |
| S-2001 from Mitsubishi Rayon Co., Ltd. | |
| Phosphorous flame retardant | 24 |
| PX-200 from Daihachi Chemical Industry Co., Ltd. | |

The mixture was placed by a hopper in a biaxial kneading extruder KZW20TW from Technovel Corp., and melted and kneaded at 210° C. thereby to prepare a pellet of 3 mm square.

### Comparative Example 5

The following materials were subjected to dry blending to prepare a mixture.

| | |
|---|---|
| Impact modifying polystyrene (HIPS) | 65 |
| collected from home electric appliances | |
| General-purpose polystyrene | 10 |
| Toyo styrol GP-G100C from Toyo Styrene Co., Ltd. | |
| Impact modifier | 5 |
| S-2001 from Mitsubishi Rayon Co., Ltd. | |
| Phosphorous flame retardant | 20 |
| PX-200 from Daihachi Chemical Industry Co., Ltd. | |

The mixture was placed by a hopper in a biaxial kneading extruder KZW20TW from Technovel Corp., and melted and kneaded at 210° C. thereby to prepare a pellet of 3 mm square.

### Comparative Example 6

The following materials were subjected to dry blending to prepare a mixture.

| | |
|---|---|
| Impact modifying polystyrene (HIPS) | 50 |
| collected from home electric appliances | |
| General-purpose polystyrene | 30 |
| Toyo styrol GP-G100C from Toyo Styrene Co., Ltd. | |
| Impact modifier | 10 |
| S-2001 from Mitsubishi Rayon Co., Ltd. | |
| Phosphorous flame retardant | 10 |
| PX-200 from Daihachi Chemical Industry Co., Ltd. | |

The mixture was placed by a hopper in a biaxial kneading extruder KZW20TW from Technovel Corp., and melted and kneaded at 210° C. thereby to prepare a pellet of 3 mm square.

### Comparative Example 7

The following materials were subjected to dry blending to prepare a mixture.

| | |
|---|---|
| Impact modifying polystyrene (HIPS) | 50 |
| collected from home electric appliances | |
| General-purpose polystyrene | 30 |
| Toyo styrol GP-G100C from Toyo Styrene Co., Ltd. | |
| Impact modifier | 7 |
| S-2001 from Mitsubishi Rayon Co., Ltd. | |
| Phosphorous flame retardant | 13 |
| PX-200 from Daihachi Chemical Industry Co., Ltd. | |

The mixture was placed by a hopper in a biaxial kneading extruder KZW20TW from Technovel Corp., and melted and kneaded at 210″C thereby to prepare a pellet of 3 mm square.

### Comparative Example 8

One hundred (100) parts of general-purpose polystyrene Toyo styrol GP-G100C from Toyo Styrene Co., Ltd. were melted and kneaded at 210″C by a biaxial kneading extruder KZW20TW from Technovel Corp. to prepare a pellet of 3 mm square.

Properties of the pellets prepared in Examples and Comparative Examples are shown in Table 1.

TABLE 1

| | | | | Content of |
|---|---|---|---|---|
| | Content of | Content of | Content of | Phosphorous |
| | HIPS | GPPS | Impact | Flame |
| | [% by | [% by | Modifier | Retardant |
| | weight] | weight] | [% by weight] | [% by weight] |
| Example 1 | 60 | 22 | 3 | 15 |
| Example 2 | 65 | 17 | 3 | 15 |
| Example 3 | 60 | 22 | 3 | 15 |
| Example 4 | 65 | 17 | 3 | 15 |
| Example 5 | 65 | 17 | 3 | 15 |
| Comparative | 100 | 0 | 0 | 0 |
| Example 1 | | | | |
| Comparative | 50 | 40 | 0 | 10 |
| Example 2 | | | | |
| Comparative | 85 | 0 | 10 | 5 |
| Example 3 | | | | |
| Comparative | 65 | 10 | 1 | 24 |
| Example 4 | | | | |
| Comparative | 65 | 10 | 5 | 20 |
| Example 5 | | | | |
| Comparative | 50 | 30 | 10 | 10 |
| Example 6 | | | | |
| Comparative | 50 | 30 | 7 | 13 |
| Example 7 | | | | |
| Comparative | 0 | 100 | 0 | 0 |
| Example 8 | | | | |

A vertical flame test was performed on the pellet prepared in each of Examples of Comparative Examples, and a charpy impact strength and an MFR thereof were measured.

### <Flame Resistance>

After each of the pellets was dried at 80° C. for 5 hours by a shelf-type hot-air dryer PH101 from Espec Corp., it was molded by an electromotive injection molder ROBOSHOT α100B from Fanuc Corp. having a mold clamping force of 100 tons, under the conditions of mold temperature of 40° C., cylinder temperature of 220° C., injection speed of 20 mm/sec, injection pressure of 100 MPa, and cooling time of 30 sec to prepare a test piece strip for vertical flame test having a width of 13 mm, a length of 125 mm, and a thickness of 1.6 mm.

After the test piece was aged at 50° C. for 72 hours, it was cooled for 3 hours in a desiccator having a humidity of 20%. Then, the vertical flame test was conducted according to the UL94 standard, for 5 test pieces as one set.

Specifically, the top end of each test piece was clamped to hold the test piece vertically, and absorbent cotton (0.8 g or less, about 50 mm square) was put 300±10 mm under the lower end of each test piece. Then, according to the flame test described below, drop of melt onto the absorbent cotton was confirmed. With a burner, each test piece was subjected to first flame contact for 10±1 sec from the lower end thereof, and after this, the burner was taken away from the test piece at a speed of about 300 min/sec. When the combustion became extinct, the burner was immediately returned to the lower end of the sample to perform second flame contact for 10±1 sec. The first combustion time was t1, the second combustion time was t2, and after-combustion ember lasting time after the second flame contact was t3.

Here, “after-combustion ember lasting time” means a time for which such a state lasted in which the flame was extinct from the test piece, but a red ember lasted in the test piece.

### <Judging Method of Flame Resistance>

(1) When t1 and t2 of each test piece were less than 10 sec, the judgment was V-0. When t1 and t2 of each test piece were not less than 10 sec, the judgment was V-1 or V-2.

(2) When t1+t2 of all of the 5 test pieces was less than 50 sec, the judgment was V-0. When not less than 50 sec, the judgment was V-1 or V-2.

(3) When t2+t3 of each test piece was less than 30 sec, the judgment was V-0. When not less than 30 sec, the judgment was V-1 or V-2.

(4) When the absorbent cotton was not burned with the melt, the judgment V-0 or V-1. When the absorbent cotton was burned, the judgment was V-2.

V-2 was Good, V-1 was Fair, and V-0 was Poor. When any one of (1) to (4) made different judgments, the poorer judgment was used.

### <Impact Resistance>

After each of the pellets was dried at 80° C. for 5 hours by a shelf-type hot-air dryer PH101 from Espec Corp., it was molded by an electromotive injection molder ROBOSHOT α100B from Fanuc Corp. having a mold clamping force of 100 tons, under the conditions of mold temperature of 40° C., cylinder temperature of 220° C., injection speed of 20 mm/sec, injection pressure of 100 MPa, and cooling time of 30 sec to prepare a test piece strip for charpy impact test having a width of 4 mm, a length of 80 mm, and a height of 10 mm.

The test piece strip was subjected to charpy impact strength test according to JIS K7111-1. Not less than 6 kJ/m² was Good, not less than 4 kJ/m² and less than 6 kJ/m² was Fair, and less than 5 kJ/m² was Poor.

### <Fluidity>

After each of the pellets was dried at 80° C. for 5 hours, MFR thereof was measured for 3 times by Melt Indexer D4003 from DJL, Inc. according to ISO 1133-A, and averaged. When measured, the temperature was 200° C. and the load was 5.0 kgf. The average not less than 50 g/10 min was Good, not less than 20 g/10 min and less than 50 g/10 min was Fair, and less than 20 g/10 min was Poor.

The results of the vertical flame test, the charpy impact strength and the MFR of the pellet prepared in each of Examples of Comparative Examples are shown in Table 2.

TABLE 2

| | Flame Resistance | Impact Resistance | Fluidity |
|---|---|---|---|
| Example 1 | Good | Good | Good |
| Example 2 | Good | Good | Good |
| Example 3 | Good | Good | Good |
| Example 4 | Good | Good | Good |
| Example 5 | Good | Good | Good |
| Comparative Example 1 | Poor | Good | Poor |
| Comparative Example 2 | Fair | Poor | Good |
| Comparative Example 3 | Poor | Good | Poor |
| Comparative Example 4 | Good | Fair | Fair |
| Comparative Example 5 | Good | Good | Poor |
| Comparative Example 6 | Fair | Good | Fair |
| Comparative Example 7 | Fair | Good | Fair |
| Comparative Example 8 | Poor | Poor | Good |

Table 2 proves each of the pellets in Examples 1 to 5 has good flame resistance, impact resistance and fluidity, and applicable to OA equipment.

Formed of PS collected from wasted home electric appliances, the pellet in Comparative Example 1 deteriorates in flame resistance and fluidity.

Including PS collected from wasted home electric appliances, GPPS and impact modifier in amounts of 50%, 40% and 0% by weight, respectively, the pellet in Comparative Example 2 deteriorates in flame resistance and impact resistance.

Including PS collected from wasted home electric appliances, GPPS, impact modifier and phosphorous flame retardant in amounts of 85%, 0%, 10% and 5% by weight, respectively, the pellet in Comparative Example 3 deteriorates in flame resistance and fluidity.

Including GPPS, impact modifier and phosphorous flame retardant in amounts of 10%, 1% and 24% by weight, respectively, the pellet in Comparative Example 4 deteriorates in impact resistance and fluidity.

Including GPPS, impact modifier and phosphorous flame retardant in amounts of 10%, 5% and 20% by weight, respectively, the pellet in Comparative Example 5 deteriorates in fluidity.

Including PS collected from wasted home electric appliances and impact modifier in amounts of 50% and 7 to 10% by weight, respectively, the pellet in Comparative Examples 6 and 7 deteriorate in flame resistance and fluidity.

Formed of GPPS, the pellet in Comparative Example 8 deteriorates in flame resistance and impact resistance.

Having now fully described the invention, it will be apparent to one of ordinary skill in the art that many changes and modifications can be made thereto without departing from the spirit and scope of the invention as set forth therein.

What is claimed is:

1. A recycled resin composition, comprising:
polystyrene collected from wasted home electric appliances in an amount of from 51 to 84% by weight;
unused polystyrene in an amount of from 11 to 39% by weight;
an impact modifier in an amount of from 2 to 4% by weight; and
a phosphorous flame retardant in an amount of from 6 to 19% by weight.

2. A component formed of the recycled resin composition according to claim 1.

3. The component of claim 2, which is a component of an image forming apparatus.

4. The component of claim 3, which is an interior component of the image forming apparatus.

5. The component of claim 2, which is assigned with information for identifiably a material and a grade.

6. An image forming apparatus, comprising the component according to claim 2.

7. A method of preparing the recycled resin composition according to claim 1, comprising:
melting and kneading a composition comprising the polystyrene collected from wasted home electric appliances, the unused polystyrene, the impact modifier, and the phosphorous flame retardant.
